(19) United States
(12) Patent Application Publication
(10) Pub. No.: US 2003/0221887 A1
(43) Pub. Date: Dec. 4, 2003

(54) Electric wheel structure capable of being directly driven by power of motor

(76) Inventor: Chun-Pu Hsu, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/160,403

(22) Filed: Jun. 4, 2002

(51) Int. Cl. B60K 1/00

(52) U.S. Cl. 180/180; 180/65.6

(57) ABSTRACT

The present invention provides an electric wheel structure capable of being directly driven by motor power, wherein a wheel, a motor, and a power transmission structure are jointly structured to directly drive an electric wheel. The object is to provide a better power transmission efficiency and avoid the contamination of external environment to the power transmission structure, thereby enhancing the power transmission efficiency, lengthening the lifetime of use of the electric vehicle, and simplifying the maintenance. The present invention lets the power transmission structure directly drive a wheel axle. A support frame bearing is installed between the wheel axle and a wheel support frame, and is used as a transmission interface between the vehicle load and the wheel axle. The motor structure body is fixedly installed at the wheel support frame. The power transmission output end directly drives the wheel axle to lead the wheel structure to rotate.

### FIELD OF THE INVENTION

The present invention relates to change of the power transmission structure of an electric vehicle and, more particularly, to simplification through common structure of the power transmission structure, the motor, and the wheel axle of a conventional electric vehicle, thereby enhancing the power transmission efficiency, lengthening the lifetime of use of the power system, and simplifying the maintenance.

### BACKGROUND OF THE INVENTION

The power transmission structure, the motor for outputting power, and the wheel structure for bearing the vehicle weight are separate in a conventional electric vehicle. The extra power transmission structure is used to connect and transmit power between the motor and the wheel. The power transmission structure is exposed outside (e.g., U.S. Pat. Nos. 5,934,401 and 5,937,964). The power transmission structure usually uses a closed ringed belt or chain to transmit power. Combination with the power transmission structure inevitably causes difficult control of alignment accuracy of the X-axle (horizontal) and Y-axle (vertical) of fixing devices for the motor and the wheel. Difficult control of alignment accuracy and transmission structure of belt and chain will affect the power transmission efficiency and result in difficult control of transmission noise. Simultaneously, because the electric vehicle is mobile, the difference in the environment where it works is large. If the power transmission is contaminated by rainwater, dust, and mud, trouble in maintenance and lifetime of use of the power system will arise.

### SUMMARY OF THE INVENTION

The present invention improves the power transmission structure of a conventional electric vehicle to simplify the power transmission structure and enhance the power transmission efficiency. Moreover, because the accuracy of the power transmission structure can be easily controlled, the power transmission noise can be controlled and the lifetime of use can be lengthened.

The present invention adds in a load bearing as a transmission interface between an axle and a wheel support frame of the wheel structure of a conventional electric vehicle. The outer diameter of the bearing directly contacts a bearing cavity installed at a support frame, and bears the load of the electric vehicle. The inner diameter of the bearing is passed by the axle of a wheel structure to correspondingly support the load and motion force of the electric vehicle and rotate with respect to the outer diameter of the bearing. One end of the wheel axle protrudes out of an end face of the support bearing. The protruding wheel axle end is connected with a power output end of the power transmission system to output power via the wheel axle to the wheel, thereby driving the electric vehicle to move.

The various objects and advantages of the present invention will be more readily understood from the following detailed description when read in conjunction with the appended drawing, in which:

### BRIEF DESCRIPTION OF THE DRAWINGS

FIGS. 1A˜1B are perspective assembly views of a first embodiment of the present invention, wherein a torsion output mounting end 318 of an output portion 317 of a deceleration gear set comprises a unidirectional bearing 319;

FIGS. 2A˜2B are perspective assembly views of a second embodiment of the present invention, wherein a torsion output mounting end 318 of an output portion 317 of a deceleration gear set does not comprise a unidirectional bearing 319;

FIGS. 3A˜3B are perspective assembly views of a third embodiment of the present invention, wherein a central unidirectional bearing match hole 218 of a wheel body 211 comprises a unidirectional bearing 220;

FIGS. 4A˜4B are perspective assembly views of a fourth embodiment of the present invention, wherein a central unidirectional bearing match hole 218 of a wheel body 211 comprises a unidirectional bearing 220 and a wheel support bearing 219;

FIGS. 5A˜5B are perspective views of relative positions of a wheel structure 21 and a motor power transmission structure 31 of the present invention after they are separately assembled;

FIG. 6 is a perspective view of the present invention showing relative positions of a wheel structure 21 installed at an E-scooter and a motor power transmission structure 31; and

FIG. 7 is a perspective view of the present invention showing a wheel structure 21 and a motor power transmission structure 31 are separately assembled and then installed at an E-scooter.

### DETAILED DESCRIPTION OF THE PREFERRED EMBODIMENTS

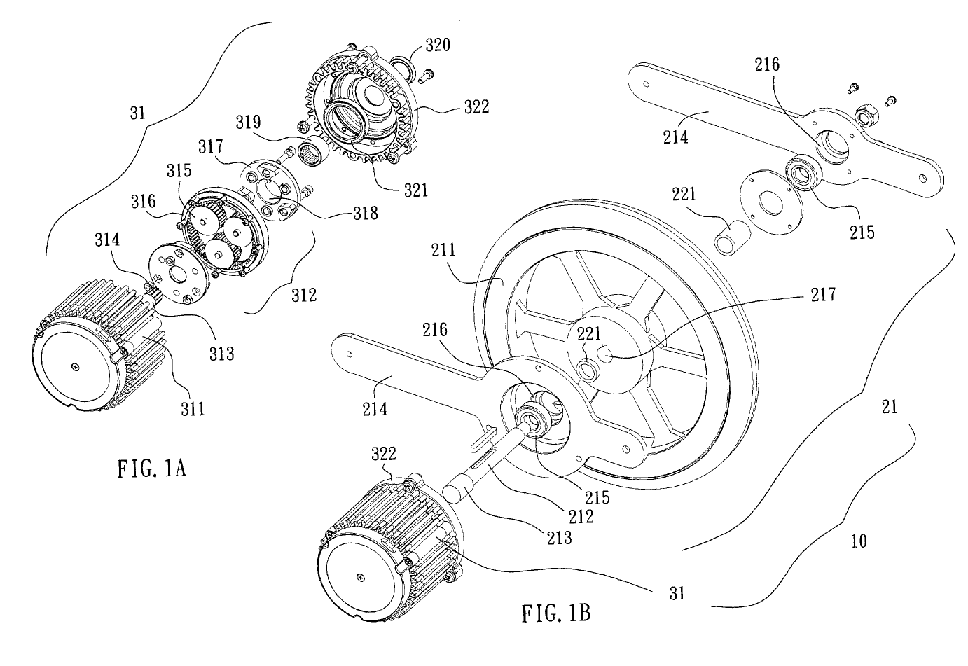

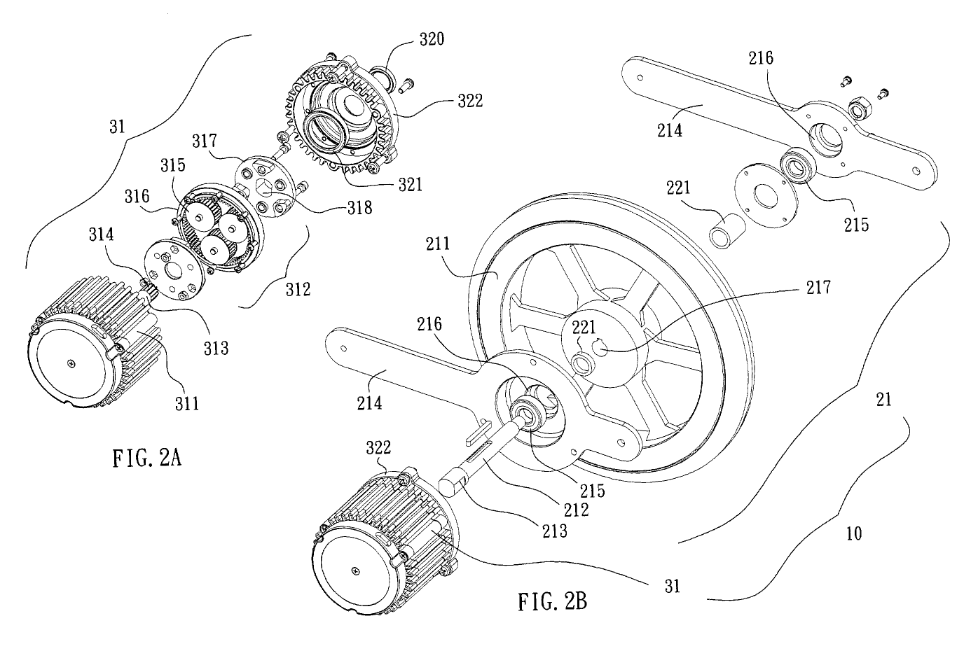

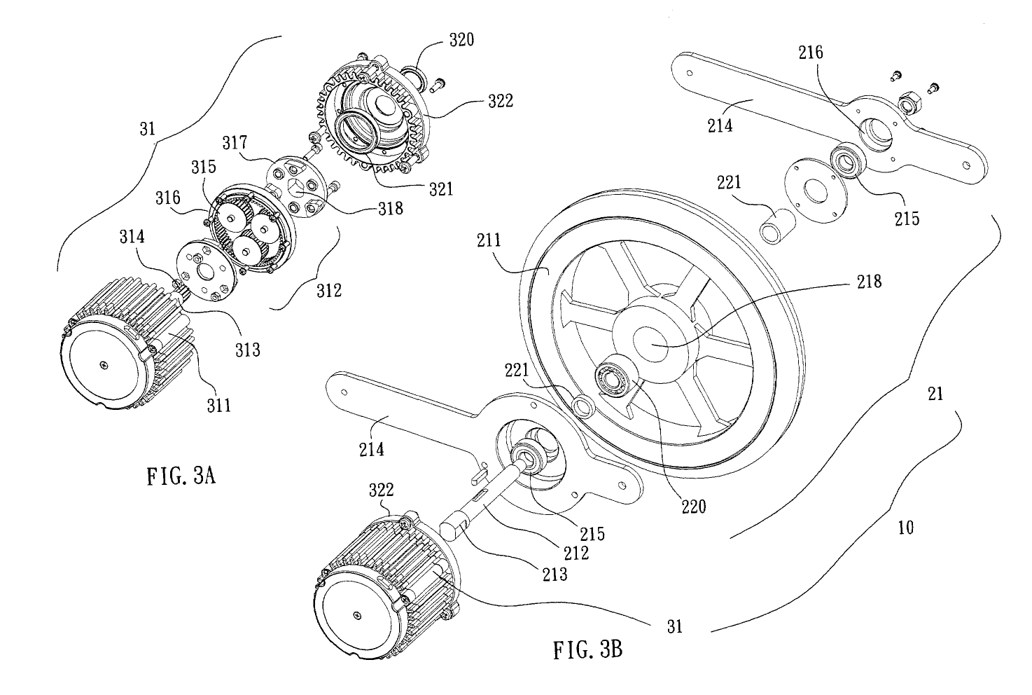

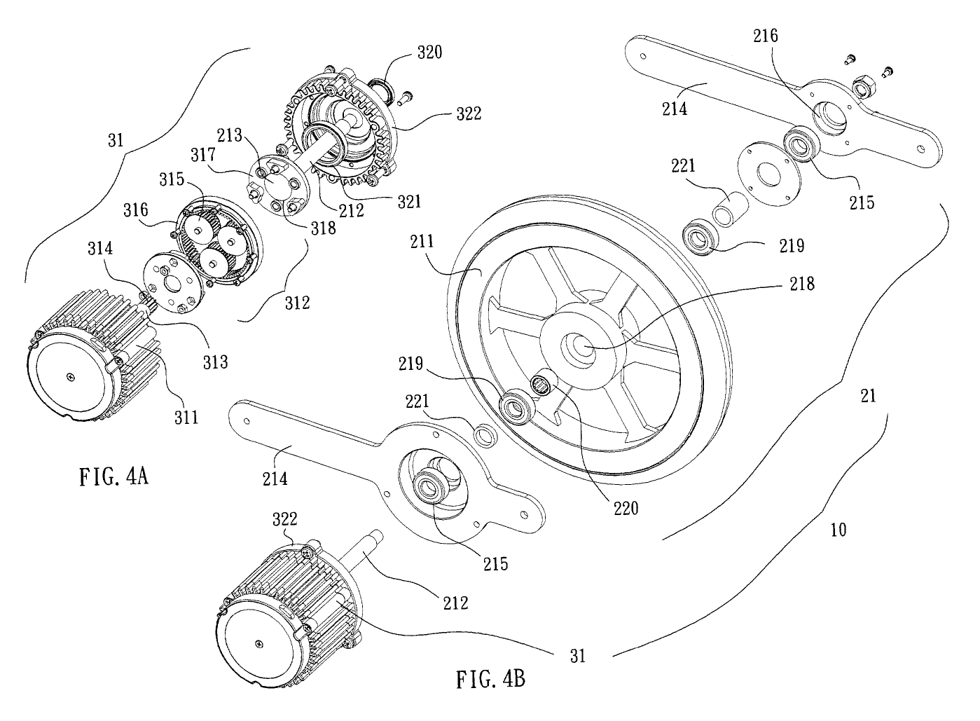

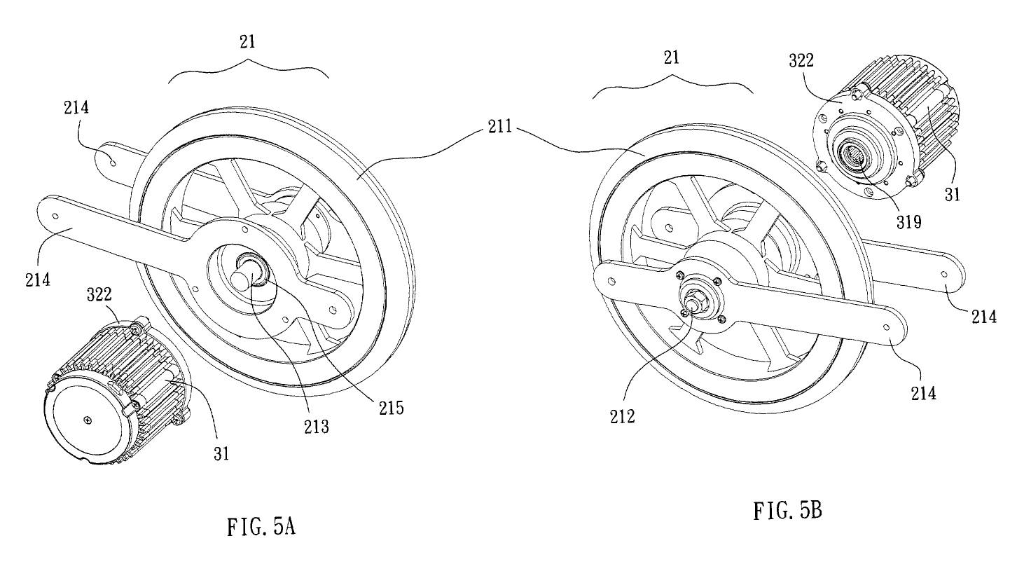

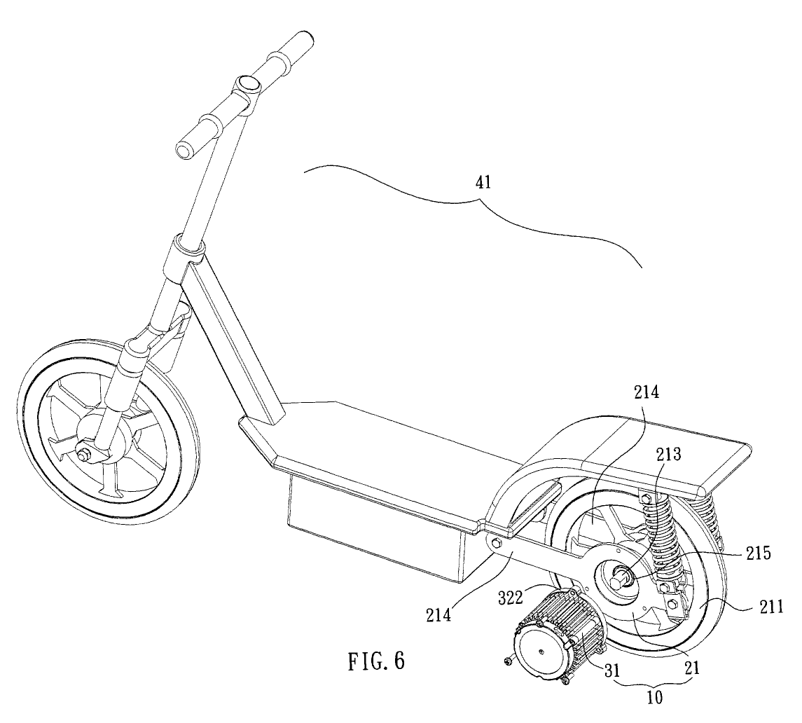

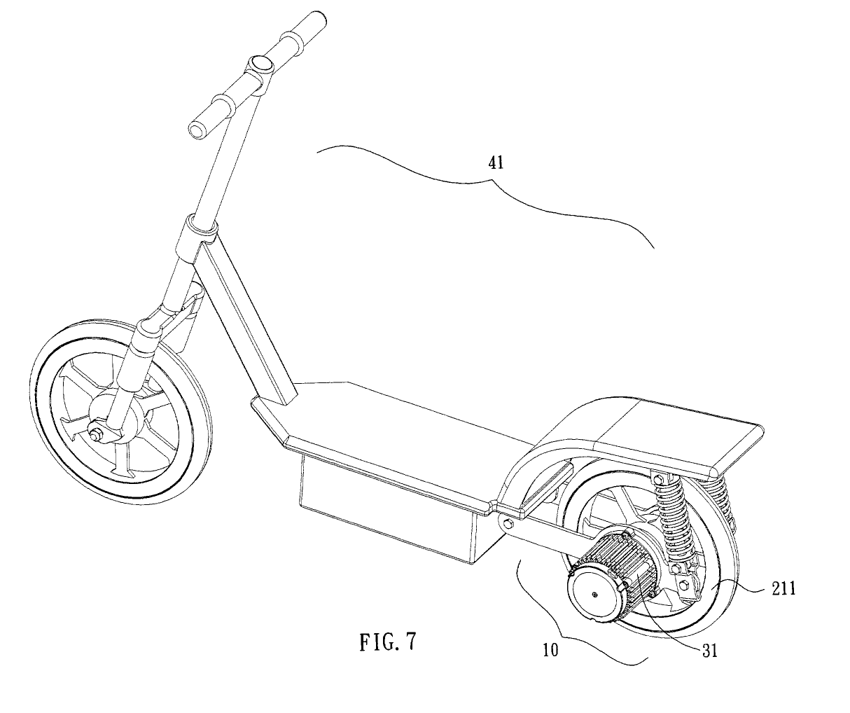

As shown in FIGS. 1 to 7, the present invention provides an electric wheel structure 10 directly driven by power of motor, which comprises a wheel structure 21 and a motor power transmission structure 31.

The wheel structure 21 comprises a wheel body 211, a wheel axle 212, a wheel support frame 214, and a support frame bearing 215. The support frame bearing 215 is installed at a bearing cavity 216 of the wheel support frame 214. The wheel axle 212 passes through the inner diameter of the support frame bearing 215 and a central match hole 217 of the wheel body 211. The wheel axle 212 at least has an end protruding out of an end face of the support frame bearing 215 as a mounting axle end 213. The wheel axle 212 bears the vehicle load via the support frame bearing 215 and the support frame 214. The mounting axle end 213 also corresponds to the motor power transmission structure 31 to synchronously rotate, thereby driving the wheel body 211 to rotate.

The motor power transmission structure 31 comprises a motor 311 and a deceleration gear set 312. The motor 31 comprises a gear of a motor axle 313 for torsion output. The gear engages a gear at the input end of the deceleration gear set 312 to rotate correspondingly. The deceleration gear set 312 has an output portion 317 of reduced rotation speed but correspondingly enlarged torsion. The output portion 317 has a torsion output mounting end 318, which is slipped with the mounting axle end 213 of the wheel axle 212. The torsion output mounting end 318 and the mounting axle end 213 are mounted together for transmission output of torsion of the motor.

The torsion output mounting end 318 of the deceleration gear output portion 317 comprises a tightly installed unidirectional rotation bearing 319. The mounting axle end 213 of the wheel axle 212 should be slipped into the inner diameter of the unidirectional rotation bearing 319. The unidirectional rotation bearing 319 only transmits torsion output of the motor. But when the motor does not generate torsion or the rotation speed of the deceleration gear output portion 317 is lower than the rotation speed of the wheel 211, the wheel axle 212 corresponding to the deceleration gear output portion 317 will idle and will not transmit torsion output of the motor.

The geometrical structure of the torsion output mounting end 318 of the deceleration gear output portion 317 corresponds to that of the mounting axle end 213. The torsion output mounting end 318 and the mounting axle end 213 can be mounted and slipped together. Motor power is outputted via the mounted and slipped end to the wheel body 211.

The wheel body 211 can comprise a wheel's unidirectional rotation bearing 220, which is concentrically and tightly installed in the central unidirectional bearing hole 218 of the wheel body 211. The wheel axle 212 passes through and is positioned at the inner diameter of the wheel's unidirectional rotation bearing 220. Motor power is transmitted by the transmission structure to let the wheel axle 212 and the wheel's unidirectional rotation bearing 220 drive the wheel body 211 to rotate. But when the motor does not generate torsion or the rotation speed of the wheel axle 212 is lower than the rotation speed of the wheel 211, the wheel axle 212 corresponding to the wheel body 211 will idle and will not transmit torsion output of the motor.

The wheel body 211 can comprise a wheel's unidirectional rotation bearing 220 and a wheel support rotation bearing 219. The wheel's unidirectional rotation bearing 220 is concentrically and tightly installed in the central unidirectional bearing hole 218 of the wheel body 211. The wheel support rotation bearing 219 is concentrically slipped at the outside end of the wheel's unidirectional rotation bearing 220. The wheel axle 212 passes through the inner diameter of the wheel's unidirectional rotation bearing 220 and the inner diameter of the wheel support rotation bearing 220. The wheel's unidirectional rotation bearing 220 only transmits torsion output of the motor. But when the motor does not generate torsion or the rotation speed of the wheel axle 212 is lower than the rotation speed of the wheel 211, the wheel axle 212 corresponding to the wheel body 211 will idle and will not transmit torsion output of the motor.

The mounting axle end 213 of the wheel axle 212 and the torsion output mounting end 318 of the deceleration gear output portion 317 are tightly joined together.

The deceleration gear set 31 is a planetary gear module. The torsion output bearing gear is a solar gear 314. The solar gear 314 equiangularly engages a plurality of planetary gears 315. The planetary gears 315 then equiangularly engage inner gears 316 at the outer edge. The solar gear 314, the planetary gears 315, and the inner gears 316 equiangularly engage one another to decelerate the rotation speed and enlarge the torsion output of motor.

The wheel support frame 214 is installed between the wheel body 211 and the motor power transmission structure 31 to let the wheel body 211 be a unilaterally supported structure. Another wheel support frame 214 can also be installed at the other side of the wheel body 211 to let the wheel body 211 be a bilaterally supported structure. The geometrical structure of the wheel support frame 214 is not limited to a specific type, and can be varied according to the matching requirement of the whole structure of an electric vehicle.

The magnitude of outer diameter and the shape of the wheel body 211 are not limited. Moreover, it is not restricted that the wheel structure 21 be installed at any specific electric vehicle.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. An electric wheel structure capable of being directly driven by motor power, comprising:
a wheel structure comprising a wheel body, a wheel axle, a wheel support frame, and a support frame bearing, said support frame bearing being installed at a bearing cavity of said wheel support frame, said wheel axle passing through the inner diameter of said support frame bearing and a central match hole of said wheel body, at least one end of said wheel axle protruding out of an end face of said support frame bearing as a mounting axle end, said wheel axle bearing the vehicle load via said support frame bearing and said support frame, said mounting axle end also corresponding to said motor power transmission structure to synchronously rotate so as to drive said wheel body to rotate; and
a motor power transmission structure comprising a motor and a deceleration gear set, said motor including an axle gear for torsion output, said axle gear engaging an input end gear of said deceleration gear set to rotate correspondingly, said deceleration gear set having an output portion of reduced rotation speed but correspondingly enlarged torsion, said output portion having a torsion output mounting end, said torsion output mounting end being slipped with said mounting axle end of said wheel axle, said torsion output mounting end and said mounting axle end being mounted together for transmission of motor's torsion output.

2. The electric wheel structure capable of being directly driven by motor power as claimed in claim 1, wherein said torsion output mounting end of said deceleration gear output portion comprises a tightly installed unidirectional rotation bearing, said mounting axle end of said wheel axle should be slipped into the inner diameter of said unidirectional rotation bearing, said unidirectional rotation bearing only transmits torsion output of motor, said wheel axle corresponding to said deceleration gear output portion will idle and will not transmit torsion output of motor when said motor does not generate torsion or the rotation speed of said deceleration gear output portion is lower than the rotation speed of said wheel.

3. The electric wheel structure capable of being directly driven by motor power as claimed in claim 1, wherein the geometrical structure of said torsion output mounting end of said deceleration gear output portion corresponds to that of said mounting axle end, said torsion output mounting end and said mounting axle end can be mounted and slipped together, and motor power is outputted via the mounted and slipped end to said wheel body.

4. The electric wheel structure capable of being directly driven by motor power as claimed in claim 1, wherein said wheel body comprises a wheel's unidirectional rotation bearing concentrically and tightly installed in a central unidirectional bearing hole of said wheel body, said wheel axle passes through and is positioned at the inner diameter of said wheel's unidirectional rotation bearing, motor power is transmitted by the transmission structure to let said wheel axle and said wheel's unidirectional rotation bearing drive said wheel body to rotate, said wheel axle corresponding to said wheel body will idle and will not transmit torsion output of motor when said motor does not generate torsion or the rotation speed of said wheel axle is lower than the rotation speed of said wheel.

5. The electric wheel structure capable of being directly driven by motor power as claimed in claim 1, wherein said wheel body comprises a wheel's unidirectional rotation bearing and a wheel support rotation bearing, said wheel's unidirectional rotation bearing is concentrically and tightly installed in a central unidirectional bearing hole of said wheel body, said wheel support rotation bearing is concentrically slipped at an outside end of said wheel's unidirectional rotation bearing, said wheel axle passes through the inner diameter of said wheel's unidirectional rotation bearing and the inner diameter of said wheel support rotation bearing, said wheel's unidirectional rotation bearing only transmits torsion output of motor, said wheel axle corresponding to said wheel body will idle and will not transmit torsion output of motor when said motor does not generate torsion or the rotation speed of said wheel axle is lower than the rotation speed of said wheel.

6. The electric wheel structure capable of being directly driven by motor power as claimed in claim 1, wherein said mounting axle end of said wheel axle and said torsion output mounting end of said deceleration gear output portion are tightly joined together.

7. The electric wheel structure capable of being directly driven by motor power as claimed in claim 1, wherein said deceleration gear set is a planetary gear module, said torsion output bearing gear is a solar gear, said solar gear equiangularly engages a plurality of planetary gears, said plurality of planetary gears then equiangularly engage inner gears at outer edge, said solar gear, said planetary gears, and said inner gears equiangularly engage one another to decelerate the rotation speed and enlarge the torsion output of motor.

8. The electric wheel structure capable of being directly driven by motor power as claimed in claim 1, wherein at least one of said wheel support frame is installed between said wheel body and said motor power transmission structure to let said wheel body be a unilaterally supported structure, another wheel support frame can also be installed at the other side of said wheel body to let said wheel body be a bilaterally supported structure, the geometrical structure of said wheel support frame is not limited to a specific type, and can be varied according to the matching requirement of the whole structure of an electric vehicle.

9. The electric wheel structure capable of being directly driven by motor power as claimed in claim 1, wherein the magnitude of outer diameter and the shape of said wheel body are not limited, and it is not restricted that said wheel structure be installed at any specific electric vehicle.
